(19) United States
(12) Patent Application Publication
(10) Pub. No.: US 2002/0030920 A1
(43) Pub. Date: Mar. 14, 2002

(54) Feed-forward compensation of cage frequency using a reference head in a servo-writer

(75) Inventors: ShuangQuan Min, Singapore (SG); KianKeong Ooi, Singapore (SG); Ricky Wei Watt Yeo, Singapore (SG); Wei Sung Lee, Singapore (SG); Beng Wee Quak, Singapore (SG); Chiap Heok Ang, Singapore (SG)

Correspondence Address: John R. Wahl, Merchant & Gould, 1400 Independence Plaza, Denver, CO, 80265-0100, US

(73) Assignee: Seagate Technology LLC

(21) Appl. No.: 09/875,884

(22) Filed: Jun. 6, 2001

Related U.S. Application Data
(60) Provisional application No. 60/211,550, filed on Jun. 14, 2000.

(51) Int. Cl. G11B 5/596; G11B 21/02

(52) U.S. Cl. 360/77.04; 360/75

(57) ABSTRACT

A system, modules, means, and computer readable media for and a method of compensating disturbances that cause track shape irregularities on a disc in a disc drive during a disc servo-writing process performed by a servo-writer are disclosed. The disturbances substantially attributable to a nonrepeatable runout (NRRO) are present during the servo-writing process. A substantial component of the NRRO is a cage frequency generated by a spindle motor mechanism in the disc drive. A reference cage frequency is determined during a servo-writing process by using a position sensor. Then a feed-forward input signal is determined based at least on the reference cage frequency during the servo-writing process. In addition, the feed-forward input signal is feed-forwardly transmitted to the servo-writer. In the servo-writer, the feed-forward input signal is utilized to substantially reject disturbances that cause the track shape irregularities while the servo-writing head electrically connected to the servo-writer is writing servo patterns on a user track during the servo-writing process.

### RELATED APPLICATIONS

This application claims priority of U.S. provisional application Serial No. 60/211,550, filed Jun. 14, 2000.

### FIELD OF THE INVENTION

This application relates generally to disc drive data storage devices and more particularly to a method of minimizing track shape errors caused by disturbances present in a servo-writer system during a servo-writing process.

### BACKGROUND OF THE INVENTION

Disc drives are data storage devices that store digital data in magnetic form on a rotating storage medium called a disc. Modern disc drives comprise one or more discs that are coated with a magnetizable medium and mounted on the hub of a spindle motor for rotation at a constant high speed. Each surface of a disc is divided into several thousand tracks that are tightly-packed concentric circles. Each track is given a track number among other identifying information so that a servo positioner can align a read element or a write element over a desired track.

Each track is divided into sectors. A sector can be either a data sector or a servo sector. A data sector usually contains information generated or stored by a user. A servo sector, on the other hand, contains information that is used by the servo positioner to determine the radial and circumferential position of the head relative to the disc surface and relative to the track center. Servo sectors are usually placed between a series of adjacent informational data sectors on the same track. Single or multiple data sectors may be packed between two servo sectors.

The servo sector typically has a Grey code field and a servo burst field, among other fields. The Grey code field provides coarse position information, such as the track and cylinder number, to the servo positioner. The servo burst field provides fine position information, such as the relative position of the head to the track center, to the servo positioner. In general, the servo burst field creates a positive signal profile on one side of the track centerline and a negative signal profile on the other side of the track centerline. The read head can be aligned directly over a track centerline by positioning the read head such that the sum of the burst field signals equal zero.

Servo sectors are written generally in radial wedges spread around the disc, leaving room between for the data. The servo sectors are written to the disc during a servo-writing process as a part of the disc drive manufacturing operation utilizing one or more servo-writing techniques such as a self-propagated servo-writing technique or a servo-writing machine technique. A clock signal mechanism ensures that information intended to be stored in a servo sector does not overwrite servo data in a data sector. During the servo-writing process, a timing pulse from the clock signal mechanism notifies the servo positioner when the write head is over a servo sector as opposed to over a data sector. Then, a write enable signal is turned on, and servo information is written to the servo sector on the disc. When the head is over a data sector, the write enable signal is turned off so that servo information is not stored in the data sector.

In general, the servo-writing operation records unique servo position information (such as the Grey code and the servo bursts) in every servo sector on every track. Thus, during the servo-writing operation, all tracks and sectors on a disc surface are defined. Ideally, the shape of each track on the disc surface should be a perfect circle, and the track circles should be spaced at a specific distance from each other. However, in reality, the shapes of tracks are not exactly uniform and circular. The shapes have irregularities due to various disturbances (such as, noise, spindle wobble, disc slip, changing fly height, and thermal expansion, among others) that occur during the servo-writing process.

The irregularities or imperfections in track shape and track spacing are collectively referred to as a track squeeze error. The track squeeze error is further defined into an AC track squeeze error and a DC track squeeze error. The AC track squeeze error refers to the situation in which two adjacent tracks have shape imperfections at different locations around their individual circumferences. That is, two tracks on a disc may be too close together at some points and too far apart at other points. The DC track squeeze error, on the other hand, refers to the situation in which two adjacent tracks are either closer or farther apart than a nominal distance. In other words, the spacing between the two tracks is incorrect even though the two tracks may be perfectly circular.

The term track squeeze error is often used to generally refer to the combination of both AC and DC track squeeze errors. The track squeeze is evidenced by adjacent tracks being closer than expected at certain locations on the disc. The track squeeze may generate data crosstalk between adjacent tracks (i.e., the write operation erasing the data on its neighboring track) or distortion of the servo patterns causing the servo sector to become defective.

A track closure error denotes another type of track shape imperfection that is also caused by external disturbances (such as, noise, spindle wobble, disc slip, changing fly height, and thermal expansion, etc.). The track closure error occurs when the servo-writer writes a spiral-shaped track with a large radial discontinuity at the splice point (evidenced by a position error signal (PES) splice) instead of a circular track with no radial discontinuity at any point. The track closure error unless eliminated causes servo off-track failures during normal drive operations.

Often, Zero Acceleration Path (ZAP) correction is used to minimize track position inaccuracies due to track-squeeze-type-errors after tracks are written on a disc. The basic idea of the ZAP correction is to add appropriate correction factors to the measured head position at each servo sector on a track already written on a disc. The correction factors are typically determined during or after the servo-writing process. The determined correction factors are then written back in each servo sector on the disc, usually in a dedicated field for storing the correction factors. The stored correction factors cancel all written-in track squeeze errors and allow a head to follow an improved shape of the modified track.

However, the ZAP correction cannot remedy a large track discontinuity that causes a track closure error. That is, the ZAP correction cannot effectively learn and compensate the track closure error, because the position error (measured by the PES values) at the splice point where a large radial discontinuity is present is too large for the ZAP correction to effectively remove the error.

A cage frequency is often a main cause of both the track squeeze and/or closure errors. The cage frequency is mainly generated by mechanical imperfections in the ball bearings and the cage holding the bearings in the spindle motor assembly. These mechanical imperfections in the spindle motor assembly cause spindle motor vibration also known as a non-repeatable runout (NRRO). That is, instability in the spindle motor bearing assemblies will contribute an NRRO component to the PES. Such an NRRO has a dominant sinusoidal behavior, although the amplitude, frequency and phase (relative to the disc index mark indicating the beginning of a track) of the runout do not repeat from one spindle rotation to the next. The cage frequency is the dominant frequency component of the NRRO, and in general, it is approximately 50-60% of the spindle rotational frequency.

The existence of the cage frequency in a servo-writer operation may cause serious track misregistration related to track closure errors and/or track squeeze errors. The track squeeze and closure errors caused by the cage frequency is more serious in high-density disc drives since such drives have very small track widths. For example, the cage frequency that is less than the spindle motor frequency may cause DC track squeeze errors (e.g., two adjacent tracks are either closer or farther apart than a nominal distance) during the servo-writing process. These DC squeeze errors are caused by radial disc motion triggered by the cage frequency beneath the head. In addition, the radial displacement triggered by the cage frequency may also cause the servo-writer to write a spiral-shaped track with a large radial discontinuity at the splice point.

As illustrated above, the spindle vibration or the NRRO that produces the cage frequency is caused largely by mechanical defects in the spindle motor assembly. Nevertheless, improvements in the mechanical manufacturing technique to sufficiently eliminate the track closure and squeeze errors have met with limited success. Even worse, many types of servo-writing techniques that are widely in use do not provide a mechanism to detect and reduce track squeeze and closure errors caused by the cage frequency. Accordingly, there is a need for a method and apparatus for cancellation of cage frequency during the servo-writing process in order to minimize the servo-writing errors produced by the cage frequency.

### SUMMARY OF THE INVENTION

Against this backdrop embodiments of the present invention have been developed. An embodiment of the invention described rejects disturbances that cause track shape irregularities on a disc in a disc drive during a disc servo-writing process performed by a servo-writer. The disturbances substantially attributable to a nonrepeatable runout (NRRO) are present during the servo-writing process. A substantial component of the NRRO is a cage frequency generated by a spindle motor mechanism in the disc drive. A reference cage frequency is determined during the servo-writing process by using a position sensor. Then a feed-forward input signal is determined based at least on the reference cage frequency measured during the servo-writing process. In addition, the feed-forward input signal is feed-forwardly transmitted to the servo-writer. In the servo-writer, the feed-forward input signal is utilized to substantially reject disturbances that cause the track shape irregularities while the servo-writing head, electrically connected to the servo-writer, is writing servo patterns on a user track during the servo-writing process. These and various other features as well as advantages which characterize the present invention will be apparent from a reading of the following detailed description and a review of the associated drawings.

### BRIEF DESCRIPTION OF THE DRAWINGS

FIG. 1 is a plan view of a disc drive in accordance with an embodiment of the present invention.

FIG. 2 is a graph showing time domain PES values (each value corresponding to a sector) on a track of an open control loop servo-writing system.

FIG. 3 is a graph of frequency spectrum of the time domain graph of FIG. 2.

FIG. 4 is a schematic drawing roughly depicting a cross section of a spindle motor assembly drawn to mathematically illustrate the characteristics of cage frequency on the spindle motor assembly.

FIG. 5 is a process control diagram showing feed-forward compensation of cage frequency according to an embodiment of the present invention.

FIG. 6 is a diagram generally showing the processing elements according to an embodiment of the present invention.

FIG. 7 is a schematic diagram drawn to illustrate mathematical relationship between a head and a reference head according to an embodiment of the present invention.

FIG. 8 is a feed-forward cage frequency compensation flowchart in accordance with a preferred embodiment of the invention.

### DETAILED DESCRIPTION

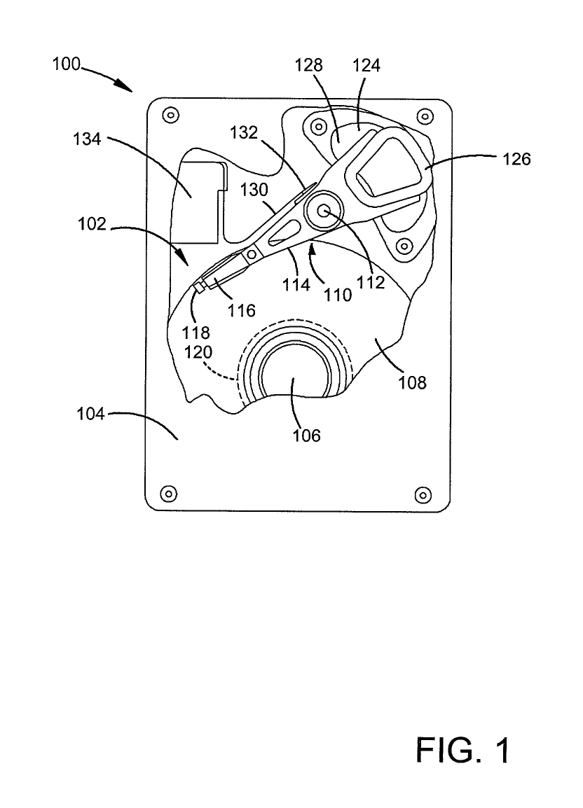

Shown in FIG. 1 is a disc drive 100 constructed in accordance with one embodiment of the present invention. The disc drive 100 includes a base 102 to which various components of the disc drive 100 are mounted. A top cover 104, shown partially cut away, cooperates with the base 102 to form an internal, sealed environment for the disc drive in a conventional manner. The components include a spindle motor 106, which rotates one or more discs 108 at a constant high speed. Information is written to and read from tracks 120 on the discs 108 through the use of an actuator assembly 110, which rotates during a seek operation about a bearing shaft assembly 112 positioned adjacent the discs 108. The actuator assembly 110 includes a plurality of actuator arms 114 which extend towards the discs 108, with one or more flexures 116 extending from each of the actuator arms 114. Mounted at the distal end of each of the flexures 116 is a head 118, which includes an air bearing slider enabling the head 118 to fly in close proximity above the corresponding surface of the associated disc 108.

During a seek operation, the track position of the heads 118 is controlled through the use of a voice coil motor (VCM) 124, which typically includes a coil 126 attached to the actuator assembly 110, as well as one or more permanent magnets 128 which establish a magnetic field in which the coil 126 is immersed. The controlled application of current to the coil 126 causes magnetic interaction between the permanent magnets 128 and the coil 126 so that the coil 126 moves in accordance with the well-known Lorentz relationship. As the coil 126 moves, the actuator assembly 110 pivots about the bearing shaft assembly 112, and the heads 118 are caused to move across the surfaces of the discs 108.

A flex assembly 130 provides the requisite electrical connection paths for the actuator assembly 110 while allowing pivotal movement of the actuator assembly 110 during operation. The flex assembly includes a printed circuit board 132 to which head wires (not shown) are connected; the head wires being routed along the actuator arms 114 and the flexures 116 to the heads 118. The printed circuit board 132 typically includes circuitry for controlling the write currents applied to the heads 118 during a write operation and a preamplifier for amplifying read signals generated by the heads 118 during a read operation. The flex assembly terminates at a flex bracket 134 for communication through the base deck 102 to a disc drive printed circuit board (not shown) mounted to the bottom side of the disc drive 100.

Tracks on a disc are defined during a servo-writing process during drive manufacture. The tracks written without shape corrections have shape irregularities due to various disturbances (such as noise, spindle wobble, disc slip, changing flying height, thermal expansion, etc.) present on the disc drive during the servo-writing process. After a track is written on a disc, the servo burst field in each servo sector provides fine position information of the track. This relative position information conveying the relative position of the head to the track center is measured in terms of a Position Error Signal (PES). The PES value is determined from A, B, C, D quadrature bursts of each servo sector on a track, and a series of the PES values is often used as a relative figure of merit as to the on-track performance of the servo system.

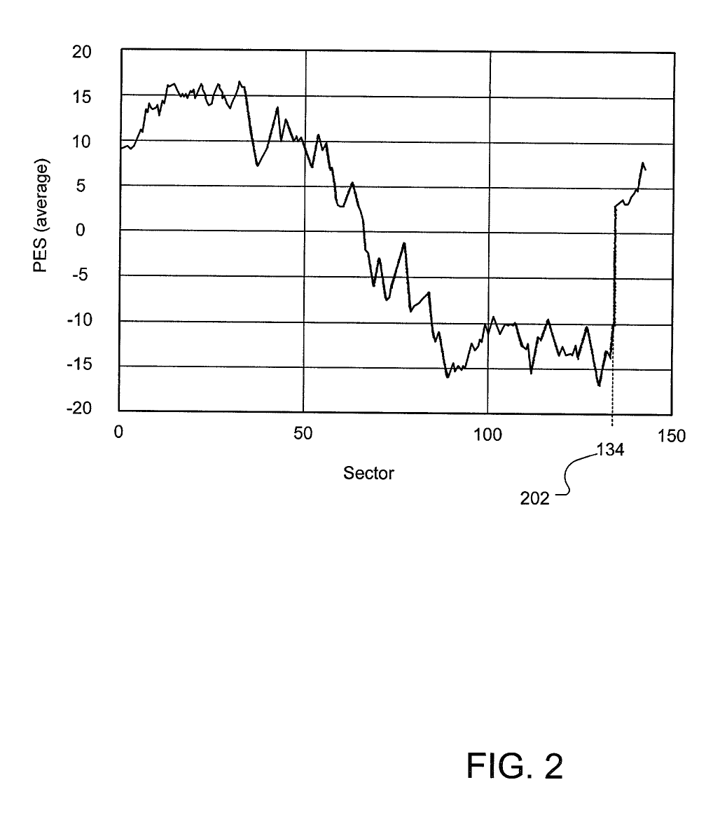

Shown in FIG. 2 is a graph of open loop PES values of a track. Each of the averaged open loop PES values (in the y-axis) sequentially corresponds to each of the sectors numbered 0 to 143 (in the x-axis) on the track. The open loop PES values are measured during a servo-writing process with no closed-loop control for correcting the track shape inaccuracies. Thus, the open loop PES values measure both a repeatable runout (RRO) and a non-repeatable runout (NRRO). An explanation for the RRO and the NRRO is as follows. Generally, disc drive motor bearing dynamics determine the precision of the spindle rotation. A disc shaft 109 (FIG. 1) is connected to a spindle bearing that is connected to a rotor of a spindle motor. As the rotor spins relative to the stator inside a spindle motor, the spinning axis of the rotor traces out an orbit. This spin-axis motion has a component that is in phase and at the same frequency as the spindle rotation, and this is known as the RRO. There is also a component of spin-axis motion that is random, and this is known as the NRRO. The spindle bearing (not shown) is the primary contributor to the NRRO. The NRRO can be caused by bearing defects, noise, spindle motor imperfections, etc. Increasing disc drive data storage density is potentially limited by the NRRO. A disc drive with low NRRO spindle bearing thus accommodates higher track density and allows higher areal density, and the improved NRRO improves seek time and ability to track follow for a given track pitch.

Since the RRO is a repeatable portion, the RRO of a sector can be generally computed by averaging all PES values measured from a sector in a given track over several revolutions. The NRRO, on the other hand, is what appears to be a non-repeatable portion in each revolution, and thus NRRO is the difference of the total PES (or the open loop PES values such as that shown in FIG. 2) and the RRO.

The largest single component of the NRRO is a cage frequency produced by imperfections in the spindle assembly. The root cause of the cage frequency may be mechanical defects in the cage. Rolling element bearings, regardless of type (ball, cylindrical, spherical, tapered, or needle) are made of an inner race and an outer race separated by the rolling elements, which are usually held in a cage. Mechanical flaws may develop on any of these components. For example, balls or rolling elements passing over a flaw on the outer or inner race of the cage may generate vibrations or frequencies. Any multiples of such a flaw combine to generate the cage frequency.

In a servo-writing process, the NRRO or the cage frequency causes the related motion between the head and the disc. Generally, the cage frequency is composed of low frequency components generated by the ball bearings and approximates 50-60% of the spindle rotational frequency. Generally, the cage frequency is non-synchronous to the spindle rotation but is periodic. That is, this periodic waveform nevertheless repeats itself at an interval longer than one spindle rotation even though it is not synchronized to the spindle rotation waveform.

The cage frequency causes radial disc motion beneath a servo-writing head and produces track spacing errors such as the track closure errors and/or track squeeze errors during a servo-writing process. The track squeeze error is evidenced by adjacent tracks to position themselves closer than expected at certain locations on the disc. It is a type of write-to-write track misregistration. The track squeeze error may generate data cross talk between adjacent tracks (i.e., the write operation has erased the data on its neighboring tracks) or distort the servo patterns and cause defective servo patterns. The track closure error is caused by a high magnitude of the cage frequency in a servo-writing process. The radial disc displacement caused by the cage frequency in effect causes the servo-writer to write a spiral, with a large radial discontinuity at the splice point. The track closure error is evidenced by a PES signal splice, and such a large radial discontinuity cannot be remedied by a ZAP correction. Such a radial discontinuity is shown in FIG. 2. The radial discontinuity is indicated by a PES splice 202 (about 10% of a track) between the servo bursts 134 and 135. This type of PES splice 202 cannot be corrected by a ZAP correction effectively and causes an offtrack-error-type drive failure unless removed.

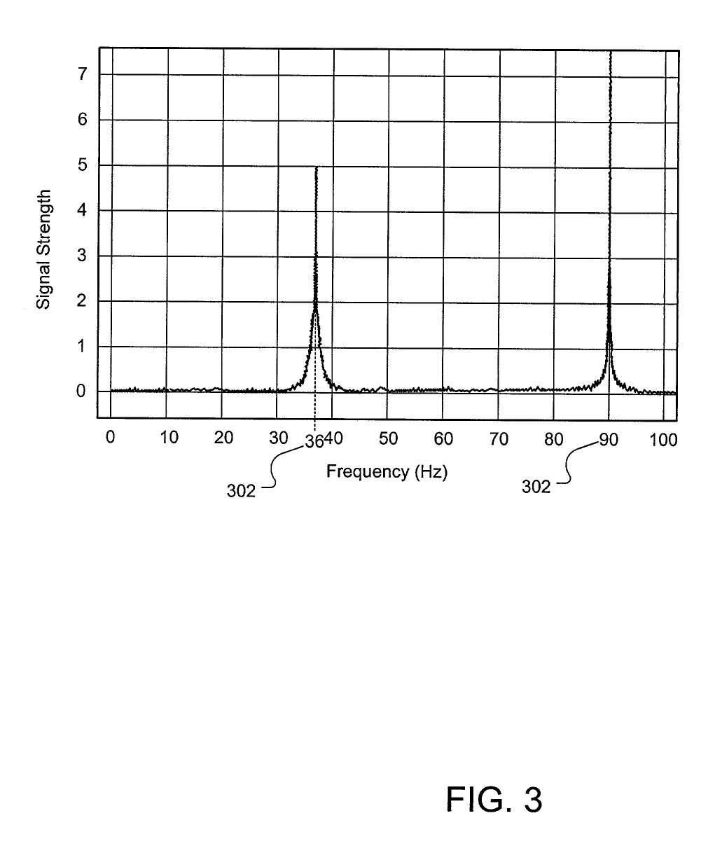

The presence of the cage frequency becomes apparent in FIG. 3, which shows a frequency spectrum of the PES values shown in FIG. 2. The frequency spectrum in FIG. 3 shows that there is an aliased cage frequency 302 of 36 Hz besides the 90 Hz spindle motor harmonics 304. As described above, the cage frequency 302 is periodic but non-synchronous to the spindle rotation frequency 304. This periodic waveform is not synchronized to the spindle but nevertheless repeats itself at intervals longer than one spindle rotation, and thus a certain phase relationship exists between the waveform of the cage frequency and the waveform of the spindle rotational frequency. However, the track squeeze and closure errors occur randomly, because the complicated phase relationship exists between the cage frequency 302, the spindle rotation 304, and the starting phase of a servo-write operation.

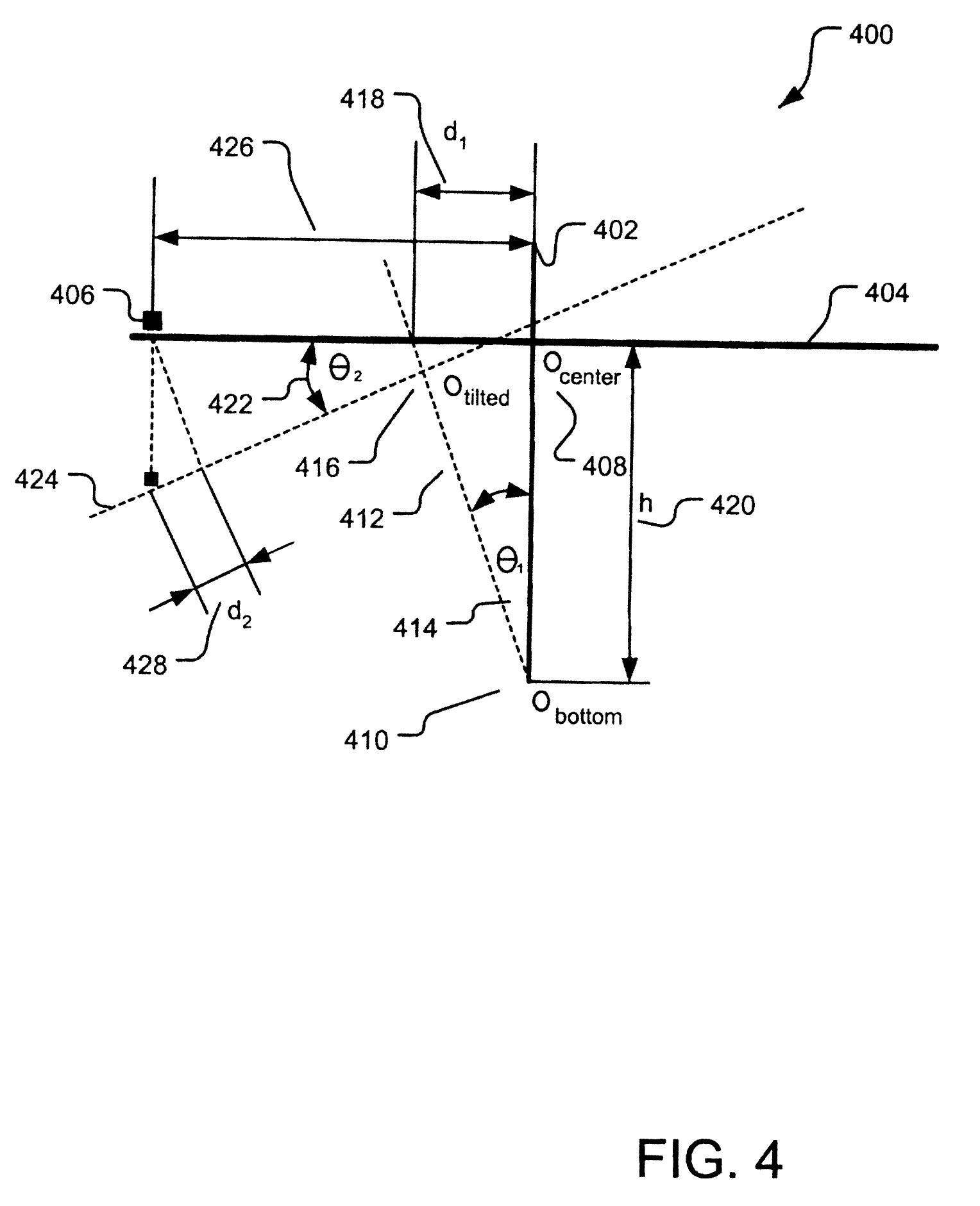

FIG. 4 is drawn to mathematically illustrate the characteristics of the cage frequency that causes disturbances in the spindle motor assembly 400. Generally, a hard disc assembly (HDA) refers to the combination of a magnetic media disc (or discs) and an actuator assembly. Inside a HDA is a spindle motor assembly 400. Shown in FIG. 4 is a simplified schematic drawing depicting a cross section of the spindle motor assembly 400 composed of a spindle shaft 402, a single disc 404, and a head 406. The disc 404 is connected to the spindle shaft 402. Although only one disc 404 is shown for simplicity, there may be multiple discs connected to the spindle shaft 402. Not shown in FIG. 4 are a spindle motor 106 (see FIG. 1) and a ball bearing or a similar roller bearing mechanism that connects the spindle shaft 402 to the spindle motor 106.

Ideally, the spindle shaft 402 is perfectly vertically aligned as shown by O_{center} 408 and O_{bottom} 410 so that the rotating disc 404 maintains a perfectly flat planar surface, and thus a constant flying height may be maintained between the surface of the disc 404 and the head 406. However, maintaining a perfect vertical alignment of the spindle shaft 402 while it is spinning at a high speed is practically impossible as long as the spindle motor assembly 400 employs a traditional ball bearing and a spindle motor with a cage constructed by the traditional manufacturing processes. As described above, the cage frequency is created mainly due to some mechanical defects in the cage and the ball bearing in the spindle motor assembly 400. The effect of the cage frequency on the spindle motor assembly 400 is evidenced by shaft bending and disc tilt. The shaft bending, as implied by the name, refers to the rotating spindle shaft 402 deviating from the perfect vertical alignment at one or more angular positions. For an illustration, O_{bottom} 410 in FIG. 4 represents an end of the spindle shaft 402 that is connected to the ball bearing of the spindle motor assembly 400, and O_{bottom} 410 generally remains at a fixed position and acts as a pivot point of the shaft bending. The bent spindle shaft 412 deviates from the vertical spindle shaft 402 by θ₁ 414 that is the angle (∠O_{center}O_{bottom}O_{tilted}) of the bent spindle shaft 412. As a result of the shaft bending, the center of the disc O_{center} 408 is displaced to O_{tilted} 416, and thus d₁ 418 represents the total displacement due to the shaft bending. d₁ is represented by a mathematical equation written in terms of a disc height h 420 and the angle θ₁ 414 of bent spindle shaft 412 as the following:

d₁=h*sin θ₁.

For a typical HDA, the angle θ₁ 414 of the bent spindle shaft 402 is much less than 1 radians (or 57 degrees), and for θ less than 1 radians, sin θ approximates to θ (and this approximation is more precise as θ approaches closer to θ radians). Then, the total displacement due to shaft bending caused by the cage frequency is:

d₁≈h*θ₁, for θ₁<<1.

Further, the angle θ₁ 414 of the bent spindle shaft 405 is identical to an angle θ₂ 422 of a tilted disc 424 (i.e., θ₁=θ₂). The head 406 would be normally located at a radial position r 426 if there were no disc tilt related to the shaft bending. Thus, the total displacement due to the disc tilt d₂ 428 caused by the cage frequency is:

d₂=(r/cos θ₂)−r, or

d₂=r*[(1/cos θ₂)−1].

However, for θ₂ less than 1 radians:

(1/cos θ₂)−1≈(1−cos θ₂), for θ₂<<1, and therefore

d₂≈r*(1−cos θ₂).

Further, by applying the well known trigonometric relationship that

(1−cos θ)=2*sin²(½*θ) and

that sin θ approximates to θ for θ less than 1 radians, the displacement d₂ is reduced to the following equation:

d₂≈½*r*(θ₂)², for θ₂<<1.

Thus, it can be shown that the total effect on the disc due to disturbances (i.e., shaft bending and disc tilt) created by the cage frequency is:

d=d₁+d₂, or

d=(h*θ)+(½*r*θ²), where θ=θ₁=θ₂.

Therefore, a conclusion can be drawn from the above equation that the magnitude of the disturbances due to the cage frequency:

(1) varies linearly with the disc height h 420 and the radial position r 426;

(2) is larger at the outer diameter (OD) of the disc 404 than at the inner diameter (ID);

(3) varies with the different discs in the same cylinder according to the disc height h 420 (that is, the magnitude of the disturbance is larger for the top disc than for the bottom disc);

(4) is maximum at the outermost diameter on the upper surface of the top-most disc; and

(5) is minimum at the innermost diameter on the under surface of the bottom-most disc.

The cage frequency that is characterized mathematically and shown above can be measured by a dedicated position sensor or a reference head on the disc during a servo-writing process. If the cage frequency can be measured by a separate position sensor, it can be removed by operations of feed-forward disturbance compensation (or rejection). An embodiment of the present invention minimizes the effect of the cage frequency during a servo-writing process by feed-forward compensating (or rejecting) the cage frequency measured by the dedicated reference head (or a separate sensor) during a servo-writing process. Further, an embodiment of the present invention linearly calibrates the feed-forward input signal for the radial position r 426.

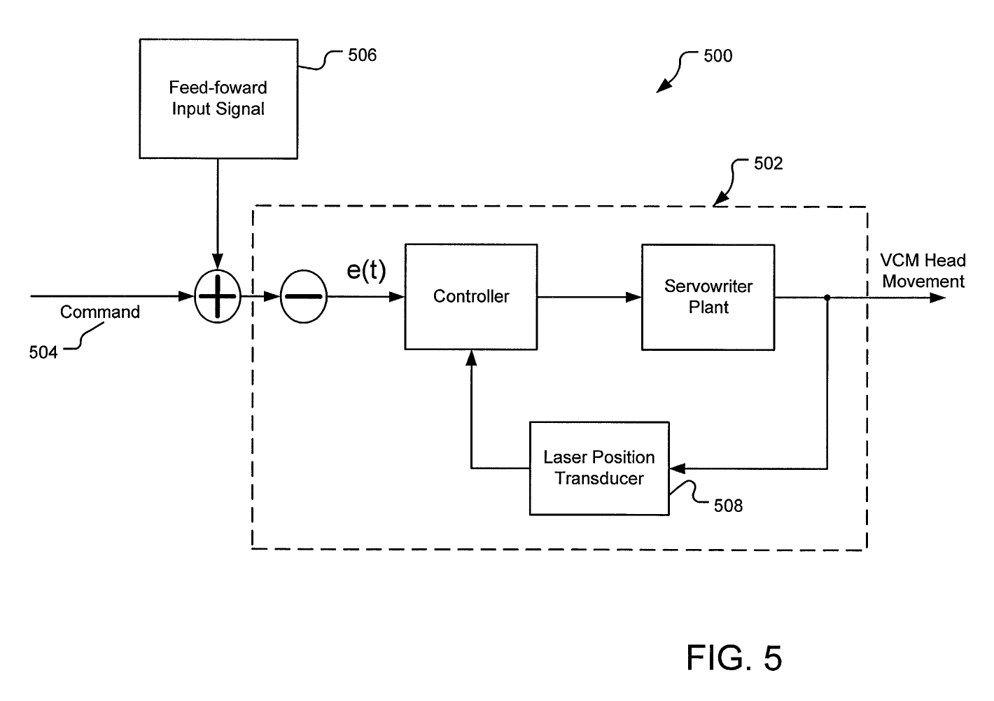

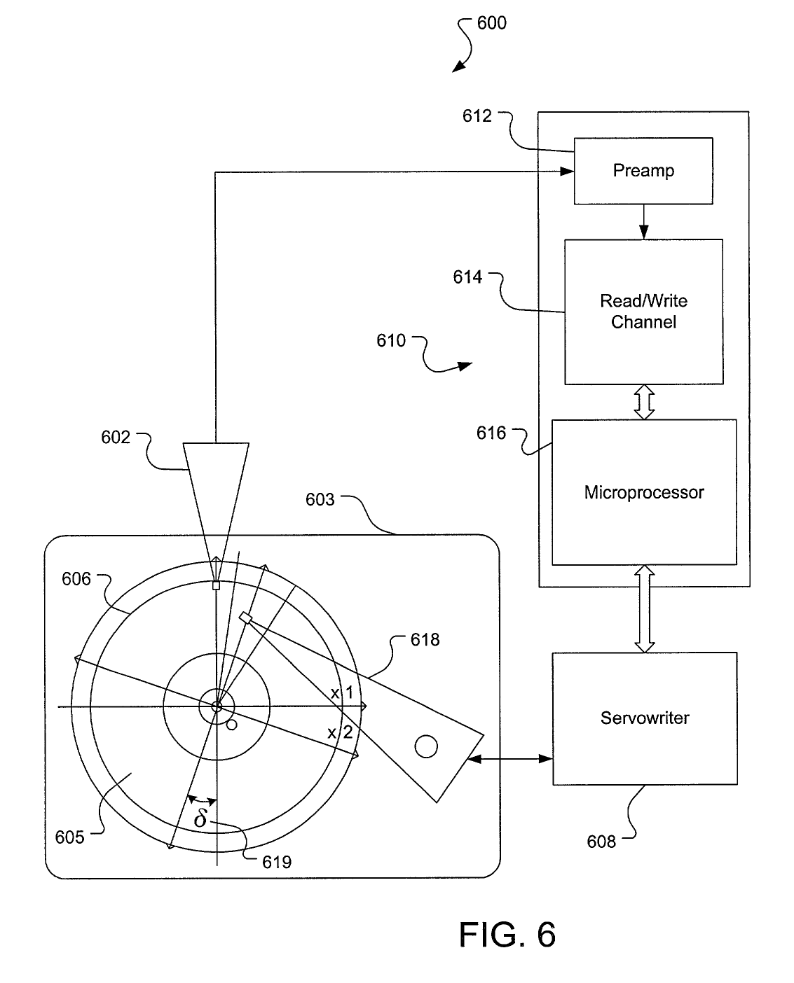

Shown therein FIG. 5 are processing elements of a servo-writing system 500 for feed-forward rejection of the cage frequency. A servo-writer control system 502 may be a closed loop laser positioning system using a direct actuator drive to position a servo-writing head (such as 406 in FIG. 4 or 604 in FIG. 6) for writing tracks. The command 504 in the servo-writer control system 502 is the expected position of the servo-writing head on a disc for writing a track. During the servo-writing process, the command 504 is constant. That is, the position of the head 406 as shown in FIG. 4 is assumed to have a constant radial position with respect to the disc center as the servo-writer control system 502 is writing a track. However, as illustrated above with respect to FIG. 4, the cage frequency generates regular movements that is substantially a sine/cosine waveform with generally a constant magnitude and a frequency relative to the spindle rotation waveform, and causes disc movements that disrupt the radial position of the head. A laser position transducer 508 in the servo-writer control system 502 measures the relative movement of the head with respect to the position information generated by the servo-writer system 500, and thus it cannot measure the relative movement between the servo-writing head and the disc caused by the cage frequency. To sense the relative movement between the head and the disc, a separate position sensor is required to sense the cage frequency. The sensed cage frequency is then converted into a feed-forward input signal 506 (to be described in detail hereinbelow). In an embodiment of the present invention, a separate reference head 602 (FIG. 6) is utilized. However, it is well known to those skilled in the art that other types of position sensors (e.g., laser or capacitive type) may be utilized instead. The separate reference head 602 (FIG. 6) and a signal processing scheme 610 (FIG. 6) are used to determine the feed-forward input signal 506 in the servo-writer system 500.

During a servo-writing process, the feed-forward input signal 506 is fed forward to the servo-writer control system 502. With the feed-forward compensation, the head takes into consideration the movement of the disc caused by the cage frequency. The effect of the cage frequency is removed as the head writes servo patterns. The head can therefore write circular tracks on the disc with negligible or no servo-writing errors due to track splice and/or track squeeze.

FIG. 6 illustrates architecture of a servo-writer system 600 that measures the cage frequency and calculates a feed-forward input signal to cancel the cage frequency in an embodiment of the present invention. The servo-writer system 600 has two heads: the reference head 602 and a servo-writing head 604. A clock head and a laser positioning system associated with the servo-writing head 604 are not shown in FIG. 6. The reference head 602 may only be a read head and may be installed on a separate arm or on the same arm that supports the clock head. During a servo-writing process, the position between the reference head 602 and a hard disc base 603 is fixed. This is the reason why the measurements made by the reference head 602 reflect the movements of a disc 605 with respect to the servo-writing head 604. Vibrations or movements of the disc 605 measured by the reference head 602, and those disc vibrations or movements measured by the reference head 602 are caused substantially by the cage frequency. This measured cage frequency information is then linearly calibrated with respect to the disc radial position r 426 (FIG. 4) and injected into the servo-writer command 504 (FIG. 5) so that the servo-writer control system 502 effectively cancels the cage frequency when writing a track on the disc 605.

In order for the reference head 602 to measure the cage frequency on the reference track, the servo-writing head 604 writes servo patterns on a reference track 606 before it writes user tracks. At the outset of a servo-writing process, the servo-writer 608 pushes the servo-writing head 604 to a track, which is located in a zone beneath the reference head 602 typically in the outside diameter (OD) of the disc outside user track zones. On this track, the servo-writing head 604 writes normal servo patterns of the reference track 606. Meantime, the reference head 602 reads the signal beneath it and checks whether there are servo patterns beneath it. When the reference head 602 finds the servo patterns beneath it, it indicates to the servo-writer system 600 that the head 604 is writing the reference track 606. The reference track 606 written by the servo-writing head 604 must have negligible or no track closure errors. This is achieved by rewriting the reference track 606 if any track shape errors are found and by verifying with the reference head that a reference track 606 with acceptably minimal shape irregularities is written. The servo-writer 608 rewrites the reference track 606 until the track shape inaccuracy is within the threshold.

The written servo pattern of each servo sector on the reference track 606 includes a Grey code field and a servo burst field. The reference head 602 determines the track number by reading the Grey code and the PES from the A, B, C, D quadrature bursts of each servo sector. While the servo-writing head 604 writes user track patterns on user tracks, the reference head 602 reads the servo bursts of the reference track 606. The A, B, C, D quadrature bursts measured by the reference head 602 is then sent to the PES Monitor 610. The PES Monitor 610 calculates the PES values and checks whether the track closure exceeds a track closure threshold for the reference track 606. The PES Monitor 610 at least includes a preamplifier 612, a read/write channel 614, and a microprocessor 616. The preamplifier 612 amplifies the signal from the reference head 602. The preamplifier 612 includes an automatic gain control function (AGC) (not shown), and the AGC of the preamplifier 612 reduces the magnitude variation of the read signal. The read/write channel 614 separates the Grey code and A, B, C, D servo bursts and converts them from analog signal to digital signal. The microprocessor 616 translates the Grey code into track number and calculates the PES using the digital A, B, C, D bursts. The calculated PES is the relative difference of the quadrature bursts A, B, C, and D, which is decided by the position of the reference head 602 on the reference track 606. The magnitude variation of the quadrature servo bursts is eliminated as a part of calculating the PES values.

Generally, there is no special requirement for the reference head 602, except that the width of the reference head 602 should not be larger than the write head 604. There are read and write elements in one data head. Usually, the write element is wider (about double) than the read element. Here we are not interested in the data read head width. This means that a reference head 602 can read the servo patterns written by the head 604 with varying track densities, typically measured in tracks per inch. The PES from the reference head 602 has the same accuracy and scale as that from the head 604 without calibration.

The magnitude variation of cage frequency from an OD to an inside diameter (ID) of a disc is cancelled with a simplified linear model. The track closure error and track squeeze error caused by the cage frequency are removed accordingly. Overall, the PES values measured by the reference head 602 generally represents a combination of both the RRO and the NRRO. To determine the cage frequency, the PES Monitor 610 calculates and cancels the RRO from the PES values of the reference track 606. As described above, the RRO can be computed by averaging PES values (each corresponding to a sector in a given track) over several revolutions since the RRO is a repeatable portion. The NRRO, on the other hand, is a non-repeatable portion in each revolution, and thus NRRO is the difference of the PES values and the RRO.

To determine the RRO, the reference head 602 reads M revolutions of the servo patterns in the reference track 606 and calculates average PES values for all servo sectors on the reference track. The PES Monitor 610 calculates the RRO on the reference track 606 as the following:

$$RRP ( n ) = {\sum }_{m = 1}^{M} \frac{P ( n , m )}{M} , \qquad [ 1 ]$$

where P(n, m) is the PES value of a servo burst on the reference track 606 that has N number of servo sectors (nε0 to N−1) for M number of revolutions (mε0 to M−1). For example, P(3,6) indicates the PES value measured at the fourth servo sector of the reference track 606 at the seventh spindle revolution. N is the total number of servo bursts in one spindle motor revolution, and M is the total number of the spindle revolution. The RRO is calculated by averaging the measured PES value, P(n,m), over the M revolutions. If the PES values measured from the reference head 602 is represented as P_{REF}(n), the cage frequency P_{CAGE}(n) measured while the servo-writing head 604 is writing the servo pattern on a user track is:

P_{CAGE}(n)=P_{REF}(n)−RRO(n). [2]

Once the cage frequency P_{CAGE}(n) is determined, the PES Monitor 610 calculates the feed-forward input signal that is inputted to the servo-writer 608 for cancellation of the cage frequency. Calculating the feed-forward input signal to the servo-writer 608 requires two further considerations: first, existence of a phase delay between the reference head 602 that measure the cage frequency and the servo-writing head 604 that writes servo pattern on a user track, and second the linear variation of cage frequency magnitude with respect to the disc radial position.

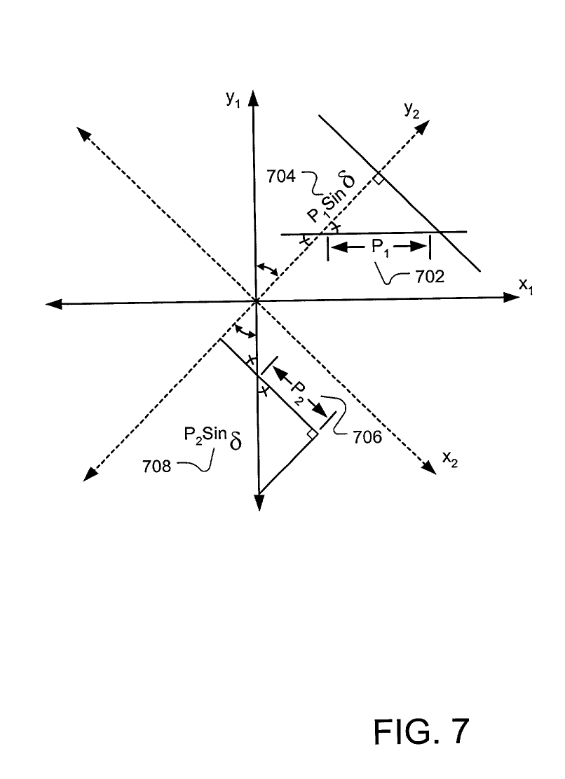

The phase delay between the reference head 602 and the servo-writing head 604 exists due to an angle δ 618 between the reference head 602 and the head 604 measured with respect to the disc center. Now referring to FIG. 7, if the disc has a movement of P₁ 702 in x₁ direction, the reference head 602 measures no movement in y₁ direction, but the head 604 measures a movement of P₁*sin δ 704 in y₂ direction. Likewise, if the disc has a movement of P₂ 706 in x₂ direction, the head 604 measures no movement in y₂ direction, but the reference head 602 measures a movement of P₂*sin δ 708 in y₁ direction. Therefore, in general, the maximum relative error between the reference head 602 and the servo-writing head 604 is sin δ. Thus, reducing the angle δ 618 can reduce this relative error between the reference head 602 and the head 604. For a small angle δ 618, the measurement error is negligible.

The angle δ 618 generally causes a constant phase delay of cage frequency between the reference head 602 and the servo-writing head 604. The cage frequency measured by the servo-writing head 604 is generally a same cage frequency waveform measured by the reference head 602 with a phase delay. This phase delay D(δ) can be shown as the following:

D(δ)=(f_{CAGE}*δ)/f_{SPINDLE}, [3]

where f_{SPINDLE} and f_{CAGE} are the spindle motor frequency and the cage frequency respectively. For example, if a cage frequency of 36 Hz exists in a spindle motor assembly with the spindle motor frequency of 90 Hz, the phase delay of the cage frequency at the head 604 positioned 30 degrees away from the reference head 602 is 12 degrees (i.e., (36)(30)/(90)).

Further, the cage frequency measured on the reference track is calibrated by a linear model in order to determine the feed-forward input signal. As already described above with respect to FIG. 4, the magnitude of the disturbances due to the cage frequency varies linearly with the radial position r 426 and is larger at the outer diameter (OD) of the disc 404 than at the inner diameter (ID). Further, the magnitude varies with the different discs in the same cylinder (that is, the magnitude of the disturbance is larger for the top disc than for the bottom disc). Thus, calibration of the cage frequency magnitude that varies linearly from ID to OD is required for each disc before the measurement is injected into the servo-writer control system.

Generally, a series of peak magnitudes of the cage frequency on the OD and ID tracks (each peak magnitude corresponding to a sector in the OD or ID track) are determined first, and the magnitudes of the cage frequencies on tracks between the OD and ID are calibrated based on the radial position of each track. To determine the peak cage frequency magnitudes on the OD track, the servo-writer 608 first moves the servo-writing head 604 to the OD of the disc and writes a calibration track at the OD before starting the servo-writing process. Nevertheless, the reference track 606 on the OD of the disc can be used as a calibration track instead. As the calibration tack is written, the reference head 602 is also placed on the same OD radial position and verifies that the calibration track being written has negligible track shape irregularities.

Once the calibration track is written, the magnitudes of the cage frequency on the calibration track are measured. Since the period of the cage frequency is generally less than the period of the spindle frequency (i.e., the cage frequency is approximately 50-60% of the spindle frequency), the number of servo bursts for one cage revolution is determined. The total number of servo bursts per one cage revolution is:

N_{CAGE}=(N_{SPINDLE}*f_{SPINDLE})/f_{CAGE}, [4]

where

N_{CAGE} is the total number of servo bursts per one cage revolution;

N_{SPINDLE} is the number of servo bursts in one spindle motor revolution;

f_{SPINDLE} is the spindle frequency; and

f_{CAGE} is the cage frequency.

That is, if the spindle motor frequency f_{SPINDLE} is 90 Hz; the number of servo bursts in one spindle motor revolution N_{SPINDLE} is 144; and the cage frequency f_{CAGE} is 36 Hz, then the number of servo bursts in one cage revolution N_{CAGE} is 360.

After determining the total number of servo bursts per one cage revolution, the cage frequency on the calibration track are determined by the following formula:

P_{CAGE}(n_{CAGE}, k)=α*P(n_{CAGE}, k)+(1−α)*P_{CAGE}(n_{CAGE}, k−1), [5]

where

n_{CAGE} is one of servo bursts numbered 0 to N_{CAGE} (nε0 to N_{CAGE});

α is the learning coefficient;

P(n_{CAGE}, k) is the magnitude of PES value at a servo burst, n_{CAGE}, in the k^{th} cage revolution; and

P_{CAGE}(n_{CAGE}, k) is the magnitude of cage frequency at a servo burst, n_{CAGE}, in the k^{th} cage revolution.

Generally, the range of the learning coefficient α is between 0 and 1. Experiments indicate that the optimal range of α is between 0.2 and 0.5.

Then, according to the formula [5], the peak magnitude of the cage frequency, P_{CAGEmax}, is:

P_{CAGEmax}=Max[P_{CAGE}(n_{CAGE}, k)]. [6]

Two calibration tracks, one on top and the other on bottom of a disc, are typically written and the cage frequencies of the both tracks are measured according to the formula described above. If the peak magnitudes of the cage frequency on the top and bottom of the calibration track are represented as P_{CTOP} and P_{CBOTTOM} respectively, the overall peak cage frequency magnitudes at the OD, P_{COD}, is determined by averaging P_{CTOP} and P_{CBOTTOM} as shown by the following formula:

$${P}_{COD} = \frac{{P}_{CTOP} + {P}_{CBOTTOM}}{2} . \qquad [ 7 ]$$

The relative error E_{cp} of the cage frequencies measured on calibration tracks between top and bottom surfaces of the disc is represented by the following formula:

$${E}_{cp} = \frac{{P}_{CTOP} - {P}_{CBOTTOM}}{{P}_{CTOP} + {P}_{CBOTTOM}} . \qquad [ 8 ]$$

Experiments indicate that the relative error E_{cp} is less than 10% for a disc drive with two discs. After determining the peak cage frequency magnitude at the OD calibration track, the servo-writer 608 moves the servo-writing head 604 to ID and writes an ID calibration track. Then an overall peak cage frequency magnitudes at the ID track P_{CID} is calculated in the same manner as P_{COD} (formulas [5]-[7]). In addition, while the peak magnitudes of expected feed-forward input signal at the ID and OD are determined, the reference head 602 measures the cage frequency on the reference track 606 and calculates the peak magnitudes of the cage frequency on the reference track, P_{CS}, by the formulas [5] and [6] above. The peak cage frequency magnitudes on the reference track P_{CS} along with P_{COD} and P_{CID} are used to determine a feed-forward input signal to the servo-writer 608 to reject the disturbances caused by the cage frequency. The derivation of the feed-forward input signal is described in more detail in the specification hereinbelow.

As shown above with respect to FIG. 4, the magnitude of the cage frequency linearly varies with radial position of the head. Thus, the magnitudes of the cage frequencies on tracks between the ID and OD of the disc can be calculated by using P_{CID} and P_{COD}. That is, the overall peak cage frequency magnitudes at OD and ID (P_{COD} and P_{CID} respectively) are used to calibrate the cage frequency magnitudes of all sectors on user tracks (to be written by the servo-writing head 604) between and including the OD and ID. For example, the cage frequency measured at the reference track 606 by the reference head 602 is calibrated with the calculated cage frequency magnitudes of the user track that is going to be written by the servo-writing head 604. The calibrated cage frequency is used to determine the feed-forward input signal, which is then fed forward to the servo-writer 608. Based on the feed-forward input signal, the servo writer 608 cancels the disturbances due to the cage frequency and directs the servo-writing head to write a user track that has negligible track shape irregularities.

If the distance between the OD calibration track and the disc center is rₒ and if the distance between the ID calibration track and the disc center is rᵢ, the distance between the OD and ID can be represented in terms of tracks or cylinders as shown by the following formula:

rₒ−rᵢ=M*T, [9]

where

M is the total number of cylinders on a disc between the ID and OD; and

T is the track density measured in tracks per inch (TPI).

A calibration factor is then determined according to the following formula:

$$\begin{matrix}Calibration\_Factor = \frac{1}{PCS} ( \frac{{P}_{COD} - {P}_{CID}}{{r}_{o} - {r}_{i}} ( {r}_{o} - m * T ) + \\ \frac{{r}_{o} * {P}_{CID} - {r}_{i} * {P}_{COD}}{{r}_{o} - {r}_{i}} )\end{matrix} \\ where \qquad [ 10 ]$$

where

Calibration_Factor represents a factor for calibrating the cage frequency;

P_{CS} represents a peak reference cage magnitude;

P_{COD} represents the overall peak magnitude of the cage frequencies measured on the upper and lower OD calibration tracks;

P_{CID} represents the is the overall peak magnitude of the cage frequencies measured on the upper and lower ID calibration tracks; and

m represents one of the cylinders (or tracks) numbered 0 to M.

Finally, a feed-forward input signal is determined based on the calibration factor and the reference cage frequency measured during the servo-writing process, and the feed-forward input signal is determined according to the formula:

p_{cf}(m)=Pcs(m)*(Calibration_Factor), [11]

where

P_{cf}(m) represents the determined feed-forward input signal for the cylinder (or the track) m;

m represents one of the cylinders (or tracks) numbered 0 to M; and

P_{CS}(m) represents the cage frequency on the reference track while the cylinder (or the track) m is written during a servo-writing process

The feed-forward input signal as shown according to the formula [11] is then feed-forwardly transmitted to the servo-writer. The feed-forward input signal is then utilized to substantially reject disturbances that cause the track shape irregularities while the servo-writing head electrically connected to the servo-writer is writing servo patterns on a user track during the servo-writing process.

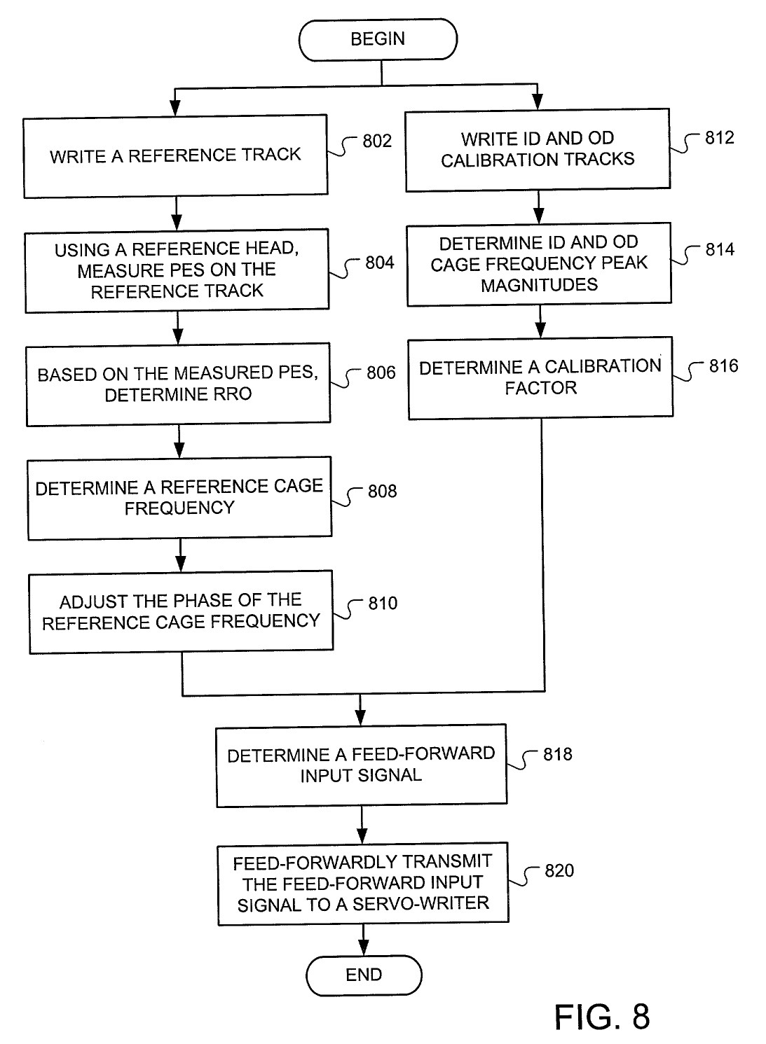

Shown in FIG. 8 is a feed-forward cage frequency compensation flowchart in accordance with a preferred embodiment of the invention. A reference track is written on a disc in operation 802. The reference track must have negligible or no track shape irregularities. This is achieved by rewriting the reference track if any track shape irregularity is found and by verifying with a dedicated reference head on the reference track that a reference track with acceptably minimal shape irregularities is written. In operation 804, the reference head reads the servo bursts (e.g., A, B, C, D quadrature bursts) of the reference track. The A, B, C, D quadrature bursts measured by the reference head are then converted into PES values. Then, repeatable runout (RRO) on the reference track is determined in operation 806. In order to determine the RRO, the reference head first reads M revolutions of the servo patterns in the reference track and calculates average PES values for all sectors on the reference track. The RRO is then calculated according to the formula [1] disclosed above. Then in operation 808, the reference cage frequency on the reference track measured during the servo-writing process is determined based at least on the RRO determined in the operation 806 and the PES values measured by the reference head. The reference cage frequency is determined according to the formula [2] disclosed above. The phase of the determined reference cage is then adjusted in operation 810. As described with respect to FIG. 6, the phase delay between the reference head 602 and the servo-writing head 604 exists due to an angle δ 618 between the reference head 602 and the head 604 measured with respect to the disc center. The angle δ 618 generally causes a constant phase delay of cage frequency between the reference head 602 and the servo-writing head 604. The cage frequency measured by the servo-writing head 604 is generally a same cage frequency waveform measured by the reference head 602 with a phase delay. This phase delay D(δ) is determined according to the formula [3] disclosed above.

The reference cage frequency is measured on the reference track. As already described above with respect to FIG. 4, the magnitude of the disturbances due to the cage frequency varies linearly with the disc height h 420 and the radial position r 426. Thus, calibration of the reference cage frequency that varies linearly from ID to OD is required before the measurement is feed-forwardly injected into the servo-writer to reject the disturbances. In determining the calibration factor, two calibration tracks (an OD calibration track and an ID calibration track) are written as shown in operation 812. Then peak magnitudes of the cage frequency on the calibration track are determined for each OD and ID calibration track according to the formulas [4]-[7] in operation 814. Meanwhile, peak magnitude of the reference cage frequency on the reference track is also determined by the reference head. In operation 816, a calibration factor is determined based on the measured reference cage frequency and the peak frequencies of the cage frequencies at the ID and OD calibration tracks and the reference track. More specifically, the calibration factor is determined according to the formula [10] disclosed above. Finally, a feed-forward input signal is determined based on the calibration factor (formula [10]) and the reference cage frequency measured during the servo-writing process. The feed-forward input signal is determined according to the formula [11] disclosed above. The feed-forward input signal as shown according to the formula [11] is then feed-forwardly transmitted to the servo-writer. The feed-forward input signal is then utilized to substantially reject disturbances that cause the track shape irregularities while the servo-writing head electrically connected to the servo-writer is writing servo patterns on a user track during the servo-writing process.

In summary, an embodiment of the present invention may be viewed as a method of compensating disturbances that cause track shape irregularities (such as 500, 600, and in operations 802-820) on a disc (such as 106) in a disc drive (such as 100) during a disc servo-writing process (such as 508 and 600). The disturbances is substantially attributable to a nonrepeatable runout (NRRO) (such as 202, 302, and 400). The NRRO is substantially caused by a cage frequency (such as 202, 302, and 400) generated in a spindle motor (such as 106) in the disc drive. The disturbances compensating method (such as such as 500, 600, and in operations 802-820) involves determining a reference cage frequency (such as in operations 802-808); determining a feed-forward input signal based on the reference cage frequency (such as in operation 818); and feed-forwardly applying the feed-forward input signal to the servo-writer (such as in operation 820). The feed-forward input signal (such as 506) substantially eliminates the track shape irregularities as track servo patterns are written by a servo-writing head (such as 618) operably connected to the servo-writer (such as 608 and 619).

In determining the reference cage frequency (such as in operations 802-808), the method involves writing a reference track that has minimal track shape irregularities (such as in operation 802) and measuring a series of Position Error Signal values (PESs) (such as in operation 804) using a reference position sensor (such as 602). Each PES value in the series corresponds to a sector on the reference track. Further, the method involves determining a multiple series of PESs by measuring PES values over multiple disc revolutions, and each series of PESs is measured over one disc revolution. Even further, the method involves determining a series of repeatable runout values (RROs) (such as in operation 806) for all sectors on the reference track (such as in formula [1]). Each RRO sequentially corresponds to a sector on the reference track (such as in formula [1]), and each RRO of a sector is an average of all PESs of the sector (such as in formula [1]). In addition, the method involves determining the reference cage frequency of the reference track (such as in operation 808) by subtracting the RRO of each sector from the PES of the same sector on the reference track (such as in formula [2]). Finally in determining the reference cage frequency (such as in operation 808), the method involves phase adjusting the reference cage frequency of the reference track (such as in operation 810 and formula [3]) based on an angular displacement of the reference position sensor relative to the servo-writing head (such as 618).

As to determining the feed-forward input signal (such as in operation 818), the method involves determining a calibration factor (such as in operations 812-816 and formula [5]), and determining the feed-forward input signal (such as in operation 818) based on the calibration factor (such as in operation 816 and formula 10) and the phase adjusted reference cage frequency that was determined during the servo-writing process (such as in operation 802-810).

As to determining the calibration factor (such as in operation 816 and formula 10), the method involves writing an OD calibration track (such as in operation 812) and an ID calibration track (such as in operation 812). The OD calibration track is located near an outer edge of the disc and the ID calibration track is located near an inner edge of the disc. Both calibration tracks have minimal track shape irregularities. Further, the method involves determining an OD cage frequency peak magnitude on the OD calibration track (such as in operation 814) and determining an ID cage frequency peak magnitude on the ID calibration track (such as in operation 814). In addition, the method involves determining the calibration factors for each sector on subsequent tracks to be written by the servo-writer based on the circumferential position of the corresponding sector (such as in operation 816 and formula [10]), the radial position of the corresponding sector with respect to the OD and ID calibration tracks (such as in operation 816 and formula [10]), and the OD and ID peak magnitudes corresponding to the radial position of the corresponding sector (such as in operation 816 and formula [10]).

An amount of adjusted phase is characterized by D(δ)=(f_{CAGE}*δ)/f_{SPINDLE} (such as in operation 810 and formula [3] where

D(δ) represents the amount of adjusted phase (such as formula [3]);

δ represents an angular displacement of the reference position sensor relative to the servo-writing head (such as 618);

f_{CAGE} represents the reference cage frequency (such as formula [3]); and

f_{SPINDLE} represents the disc rotational frequency (such as formula [3]).

Further, the calibration factor is characterized by

$$\begin{matrix}Calibration\_Factor = \frac{1}{PCS} ( \frac{{P}_{COD} - {P}_{CID}}{{r}_{o} - {r}_{i}} ( {r}_{o} - m * T ) + \\ \frac{{r}_{o} * {P}_{CID} - {r}_{i} * {P}_{COD}}{{r}_{o} - {r}_{i}} )\end{matrix}$$

$$\text{(such as in operation 816 and formula [10]), where}$$

Calibration_Factor represents a factor for calibrating the cage frequency (such as in operation 816 and formula [10]);

P_{CS} represents a peak reference cage magnitude (such as formula [10]);

P_{COD} represents the overall peak magnitude of the cage frequencies measured on the upper and lower OD calibration tracks (such as formula [10]);

P_{CID} represents the is the overall peak magnitude of the cage frequencies measured on the upper and lower ID calibration tracks (such as formula [10]);

rₒ represents the distance between the OD calibration track and the center of the disc (such as formula [10]);

rᵢ represents the distance between the ID calibration track and the center of the disc (such as formula [10]);

m represents one of the cylinders (or tracks) numbered 0 to M (such as formula [10]); and

T represents the track density measured in the unit of tracks-per-inch (TPI) (such as formula [10]).

Finally, the feed-forward input signal is characterized by

P_{cf}(m)Pcs(m)*(Calibration_Factor) (such as in operation 818 and formula [11]),

where

P_{cf}(m) represents the determined feed-forward input for the cylinder (or the track) m (such as formula [11); and

P_{CS}(m) represents the cage frequency on the reference track while the cylinder (or the track) m is written during a servo-writing process (such as formula [11).

It will be clear that the present invention is well adapted to attain the ends and advantages mentioned as well as those inherent therein. While a presently preferred embodiment has been described for purposes of this disclosure, various changes and modifications may be made which are well within the scope of the present invention. For example, the reference head may be positioned on any disc (e.g., top, middle, or bottom) and in any zone (OD, MD, or ID) although the OD of the top disc surface is usually a preferred location of the reference head. In addition, a presently preferred embodiment is not only suitable for canceling the cage frequency but also suitable for canceling other NRRO components that are generated by the spindle defects during servo-writing process. Numerous other changes may be made which will readily suggest themselves to those skilled in the art and which are encompassed in the spirit of the invention disclosed and as defined in the appended claims.

What is claimed is:

1. A method of compensating for disturbances that cause track shape irregularities on a disc in a disc drive during a disc servo-writing process, the disturbances substantially attributable to a nonrepeatable runout (NRRO) substantially caused by a cage frequency generated in a spindle motor in the disc drive, the method comprising steps of:
(a) determining a reference cage frequency;
(b) determining a feed-forward input signal based on the reference cage frequency; and
(c) feed-forwardly applying the feed-forward input signal to the servo-writer to substantially eliminate the track shape irregularities as track servo patterns are written by a servo-writing head operably connected to the servo-writer.

2. The method of claim 1 wherein the reference cage frequency determining step (a) comprises steps of:
(a)(i) writing a reference track that has minimal track shape irregularities;
(a)(ii) measuring a series of Position Error Signal values (PESs) using a reference position sensor, each PES value in the series corresponding to a sector on the reference track;
(a)(iii) determining a multiple series of PESs by repeating the step (a)(ii) over multiple disc revolutions, each series of PESs measured over one disc revolution;
(a)(iv) determining a series of repeatable runout values (RROs) for all sectors on the reference track, each RRO sequentially corresponding to a sector on the reference track, each RRO of a sector being an average of all PESs of the sector; and
(a)(v) determining the reference cage frequency of the reference track by subtracting the RRO of each sector from the PES of the same sector on the reference track.

3. The method of claim 2 wherein the reference cage frequency determining step (a) further comprises step of:
(a)(vi) phase adjusting the reference cage frequency of the reference track based on an angular displacement of the reference position sensor relative to the servo-writing head.

4. The method of claim 3 wherein the feed-forward input signal determining step (b) comprises steps of:
(b)(i) determining a calibration factor; and
(b)(ii) determining the feed-forward input signal based on the calibration factor and the phase adjusted reference cage frequency determined during the servo-writing process.

5. The method of claim 4 wherein the calibration factor determining step (b)(i) comprises steps of:
(b)(i)(1) writing an OD calibration track and an ID calibration track, the OD calibration track being located near an outer edge of the disc and the ID calibration track being located near an inner edge of the disc, both calibration tracks having minimal track shape irregularities;
(b)(i)(2) determining an OD cage frequency peak magnitude on the OD calibration track;
(b)(i)(3) determining an ID cage frequency peak magnitude on the ID calibration track; and
(b)(i)(4) determining the calibration factors for each sector on subsequent tracks to be written by the servo-writer based on the circumferential position of the corresponding sector, the radial position of the corresponding sector with respect to the OD and ID calibration tracks, and the OD and ID peak magnitudes corresponding to the radial position of the corresponding sector.

6. The method of claim 5, wherein an amount of adjusted phase of the phase adjusting step (a)(vi) is characterized by D(δ)=(f_{CAGE}*δ)/f_{SPINDLE}, wherein
D(δ) represents the amount of adjusted phase;
δ represents an angular displacement of the reference position sensor relative to the servo-writing head;
f_{CAGE} represents the reference cage frequency; and
f_{SPINDLE} represents the disc rotational frequency.

7. The method of claim 6 wherein the calibration factor of step (b)(i)(4) is characterized by
$$\begin{matrix}Calibration\_Factor = \frac{1}{PCS} ( \frac{{P}_{COD} - {P}_{CID}}{{r}_{o} - {r}_{i}} ( {r}_{o} - m * T ) + \\ \frac{{r}_{o} * {P}_{CID} - {r}_{i} * {P}_{COD}}{{r}_{o} - {r}_{i}} )\end{matrix}$$
Calibration_Factor represents a factor for calibrating the cage frequency;
P_{CS} represents a peak reference cage magnitude;
P_{COD} represents the overall peak magnitude of the cage frequencies measured on the upper and lower OD calibration tracks;
P_{CID} represents the is the overall peak magnitude of the cage frequencies measured on the upper and lower ID calibration tracks;
rₒ represents the distance between the OD calibration track and the center of the disc;
rᵢ represents the distance between the ID calibration track and the center of the disc;
m represents one of the cylinders (or tracks) numbered 0 to M; and
T represents the track density measured in the unit of tracks-per-inch (TPI).

8. The method of claim 7, wherein the feed-forward input signal determined in the step (b)(ii) is characterized by p_{cf}(m)=PCS(m)*(Calibration_Factor), wherein
P_{cf}(m) represents the determined feed-forward input signal for the cylinder (or the track) m; and
P_{CS}(m) represents the cage frequency on the reference track while the cylinder (or the track) m is written during a servo-writing process.

9. A computer readable media readable by a computer and encoding instructions for executing the method recited in claim 8.

10. A disturbance removal system for compensating for disturbances that cause track shape irregularities on a disc in a disc drive during a disc servo-writing process performed by a servo-writer moving a servo-writing head, the disturbances attributable to a nonrepeatable runout (NRRO) substantially caused by a cage frequency generated in a spindle motor in the disc drive, the disturbance removal system comprising:
a reference position sensor;
a reference cage frequency determination module electrically connected to the reference position sensor;
a feed-forward input signal determination module connected to the reference cage frequency determination module, determining a feed-forward input signal based on the reference cage frequency; and
a servo-writing module receiving the feed-forward input signal from the feed-forward input signal determination module, while the servo-writing head electrically connected to the servo-writing module is writing servo patterns on the disc during the servo-writing process.

11. The disturbance removal system of claim 10 wherein the reference cage frequency determination module comprises:
a reference track writing module causing the servo-writing module to write a reference track that has minimal track shape irregularities on the disc;
a Position Error Signal (PES) measurement module that measures a series of reference PESs detected by the reference position sensor, each reference PES of the series sequentially corresponding to each sector on the reference track;
a repeatable runout (RRO) determination module that determines a series of RROs for all sectors on the reference track, each RRO sequentially corresponding to a sector on the reference track, each RRO of a sector being an average of all PESs of the sector; and
a reference cage frequency determination module that determines the reference cage frequency by subtracting the determined RRO of each sector on the reference track from the PES of the same sector measured during the servo-writing process; and

12. The disturbance removal system of claim 11 wherein the reference cage frequency determination module further comprises a phase adjusting module that adjusts a phase of the reference cage frequency based on an angular displacement of the reference position sensor relative to the servo-writing head.

13. The disturbance removal system of claim 12 wherein the feed-forward input signal determination module comprises a calibration factor determination module that determines a calibration factor, wherein the feed-forward input signal determination module determines the feed-forward input signal based at least on the calibration factor and the phase adjusted reference cage frequency.

14. The disturbance remover of claim 13 wherein the calibration factor determination module comprises:
a calibration track writing module that writes an OD calibration track and an ID calibration track, the OD calibration track being located near an outer edge of the disc and the ID calibration track being located near an inner edge of the disc, both calibration tracks having minimal track shape irregularities;
an OD peak magnitude determination module that determines an OD cage frequency peak magnitude; and
an ID peak magnitude determination module that determines an ID cage frequency peak magnitude, wherein
the calibration factor determination module determines the calibration factors for each sector on subsequent tracks to be written by the servo-writer based on the circumferential position of the corresponding sector with respect to the OD and ID calibration tracks, and the OD and ID peak magnitudes corresponding to the radial position of the corresponding sector.

15. The disturbance removal system of claim 14, wherein an amount of adjusted phase of the phase adjusting module is characterized by D(δ)=(f_{CAGE}*δ)/f_{SPINDLE}, wherein
D(δ) represents the phase for adjustment;
δ represents an angular displacement of the reference position sensor relative to the servo-writing head on the disc;
f_{CAGE} represents the reference cage frequency; and
f_{SPINDLE} represents the disc rotational frequency.

16. The disturbance removal system of claim 15 wherein the calibration factor is characterized by
$$\begin{matrix}Calibration\_Factor = \frac{1}{PCS} ( \frac{{P}_{COD} - {P}_{CID}}{{r}_{o} - {r}_{i}} ( {r}_{o} - m * T ) + \\ \frac{{r}_{o} * {P}_{CID} - {r}_{i} * {P}_{COD}}{{r}_{o} - {r}_{i}} )\end{matrix}$$
where
Calibration_Factor represents a factor for calibrating the cage frequency;
P_{CS} represents a peak reference cage magnitude;
P_{COD} represents the overall peak magnitude of the cage frequencies measured on the upper and lower OD calibration tracks;
P_{CID} represents the is the overall peak magnitude of the cage frequencies measured on the upper and lower ID calibration tracks;
rₒ represents the distance between the OD calibration track and the center of the disc;
rᵢ represents the distance between the ID calibration track and the center of the disc;
m represents one of the cylinders (or tracks) numbered 0 to M; and
T represents the track density measured in the unit of tracks-per-inch (TPI).

17. The disturbance removal system of claim 16, wherein the feed-forward input signal is characterized by P_{cf}(m)=P_{CS}(m)*(Calibration_Factor), wherein
P_{cf}(m) represents the determined feed-forward input signal for the cylinder (or the track) m; and
P_{CS}(m) represents the cage frequency on the reference track while the cylinder (or the track) m is written during a servo-writing process.

18. A disturbance removal system for compensating for disturbances causing track shape irregularities on a disc in a disc drive during a disc servo-writing process, the disturbances attributable to a nonrepeatable runout (NRRO) generated in the disc drive, the disturbance removal system comprising:
a servo-writer that performs the servo-writing process; and
means for determining a feed-forward input signal for the servo-writer based on a reference cage frequency.

19. The disturbance removal system of claim 18 further comprising means for applying the feed-forward input signal to minimize the track shape irregularities while track servo patterns are written on the disc by a servo-writing head operably connected to the servo-writer.

20. The disturbance removal system of claim 19 wherein the feed-forward input signal is determined based on a calibration factor.

21. The disturbance removal system of claim 20 wherein the reference cage frequency is determined based on PES values measured by a reference position sensor on a reference track, each PES value corresponding to a sector on the reference track.

22. The disturbance removal system of claim 20 wherein a phase of the reference cage frequency is adjusted based on an angular displacement of the reference position sensor relative to the servo-writing head on the disc.

23. The disturbance removal system of claim 22 wherein the calibration factor is determined for each sector on each track on the disc based at least on ID and OD cage frequency peak magnitudes and radial position of each sector with respect to ID and OD calibration tracks, the ID calibration track being located near an inner edge of the disc and the OD calibration track being located near an outer edge of the disc.

24. The disturbance removal system of claim 23 wherein a series of OD cage frequency peak magnitudes is determined from sectors on the OD calibration track, each OD cage frequency peak magnitude corresponding to a sector on the OD calibration track.

25. The disturbance removal system of claim 24 wherein a series of ID cage frequency peak magnitudes is determined from sectors on the ID calibration track, each ID cage frequency peak magnitude corresponding to a sector on the ID calibration track.

26. The disturbance removal system of claim 25, wherein an amount of adjusted phase is characterized by D(δ)=(f_{CAGE}*δ)/f_{SPINDLE}, wherein
D(δ) represents the amount of adjusted phase;
δ represents an angular displacement of the reference position sensor relative to the servo-writing head;
f_{CAGE} represents the reference cage frequency; and
f_{SPINDLE} represents the disc rotational frequency.

27. The disturbance removal system of claim 26 wherein the calibration factor is characterized by
$$\begin{matrix}Calibration\_Factor = \frac{1}{PCS} ( \frac{{P}_{COD} - {P}_{CID}}{{r}_{o} - {r}_{i}} ( {r}_{o} - m * T ) + \\ \frac{{r}_{o} * {P}_{CID} - {r}_{i} * {P}_{COD}}{{r}_{o} - {r}_{i}} )\end{matrix}$$
wherein
Calibration_Factor represents a factor for calibrating the cage frequency;
P_{CS} represents a peak reference cage magnitude;
P_{COD} represents the overall peak magnitude of the cage frequencies measured on the upper and lower OD calibration tracks;
P_{CID} represents the is the overall peak magnitude of the cage frequencies measured on the upper and lower ID calibration tracks;
rₒ represents the distance between the OD calibration track and the center of the disc;
rᵢ represents the distance between the ID calibration track and the center of the disc;
m represents one of the cylinders (or tracks) numbered 0 to M; and
T represents the track density measured in the unit of track-per-inch (TPI).

28. The disturbance removal system of claim 27, wherein the feed-forward input signal is characterized by P_{cf}(m)=PCS(m)*(Calibration_Factor), wherein
P_{cf}(m) represents the determined feed-forward input signal for the cylinder (or the track) m; and
P_{CS}(m) represents the cage frequency on the reference track while the cylinder (or the track) m is written during a servo-writing process.
